(19) United States
(12) Patent Application Publication
(10) Pub. No.: US 2010/0235204 A1
(43) Pub. Date: Sep. 16, 2010

(54) IMPROVED APPARATUS AND METHOD USING A MATRIX REPOSITORY

(76) Inventor: Kalle Färkkilä, Helsinki (FI)

Correspondence Address: YOUNG & THOMPSON, 209 Madison Street, Suite 500, Alexandria, VA, 22314, US

(21) Appl. No.: 12/377,740

(22) PCT Filed: Aug. 16, 2007
(86) PCT No.: PCT/FI2007/050447

§ 371 Date: Feb. 17, 2009

(30) Foreign Application Priority Data
Aug. 17, 2006 (FI) 20065521

(51) Int. Cl. G06Q 10/00; G06F 15/18; G06F 17/30

(52) U.S. Cl. 705/7; 706/12; 707/792; 707/E17.044

(57) ABSTRACT

A method of operating an apparatus. Points of interest of an operational subject are mapped into matrix elements of one or more result matrices. Result matrices internal dependency such that a matrix operation targeted to at least one matrix element of the result matrix induces a corresponding matrix operation directed to at least one other, internally dependant matrix element of the matrix. A matrix element state being identifiable by a combination of a result matrix, matrix operation and previous state of the targeted matrix element, and associated with a specific computing rule. At matrix operation the factor value is computed and factor value and/or state is aggregated according the computing rule associated with the factor state. Operation of the apparatus is determined on the basis of a combination of values in a result matrix.

### FIELD OF THE INVENTION

The present invention relates to systems operating on the basis of information stored in a matrix.

### BACKGROUND OF THE INVENTION

As collection of information has become easier through networked information sources, technical apparatuses or systems where an operation to be performed is determined on the basis of one or more values of a matrix repository have become widespread. A matrix refers here to a plurality of elements, and each of the elements can be individualised according to its location in the matrix. An operation refers here to an action or series of parallel and/or consecutive actions triggered by one instance. Examples of such operations comprise, for example, an output function, a control function, a trigger function, a signalling function, or the like, or any combination of such functions. A technical apparatus refers herein to a group or system of elements that work together to perform a specific function. Examples of such apparatuses comprise, for example, an information system that outputs data collected and stored in the matrix repository, a control device that performs a control operation in response to a value detected in the matrix repository or computed from the values in the matrix repository, a communication system that sends a predefined signal in response to a value computed from the values of the matrix repository, an application that triggers a predefined service in response to a value computed from values in the matrix repository, and the like.

Conventionally, calculations of matrices are demanding and require heavy processing capacity. Especially in time-critical systems, for example, in on-line systems for customer use, or control devices for automated systems, the aggregated summaries and/or result matrices are needed in minimum time, so the time available for processing the calculations is very limited. In operating environments, where the information sources are more or less in control of the operator of the system, the input procedures may be predicted and thereby adjusted such that the amount of calculations necessary for updating the matrix values can be limited, and the number of other factors affected by the introduction of a new value is reduced. For example, input filters, and predefined update schemes may be used to streamline the computing effort and decrease the amount of required matrix calculations.

However, in operating environments, where information sources operate independently, input values are provided randomly, both in the time-scale and as concerns the order of target matrix element. In such environments the described conventional optimization methods are not applicable, and new, improved ways that optimize and reduce the computing effort without adding substantial restrictions to the input procedures become extremely valuable.

### SUMMARY OF THE INVENTION

An object of the present invention is thus to provide a solution so as to improve the operation of the system operating on the basis of information stored in a matrix repository. The objects of the invention are achieved by a method, an apparatus, a computer program product and a computer program distribution medium, which are characterized by what is stated in the independent claims. The preferred embodiments of the invention are disclosed in the dependent claims.

The invention is based on the idea of providing a matrix element that has an inherent structural dependency with a number of predefined states that are utilized in combination with internal dependencies to sequence, optimise and focus matrix operations in the system.

A preliminary advantage of the invention is that the amount of matrix calculations can be reduced without interfering with the operation of the input sources. Other advantages of the invention are disclosed in connection with the specific embodiments.

### BRIEF DESCRIPTION OF THE DRAWINGS

FIG. 1 illustrates an embodiment of an apparatus according to the invention;

FIG. 2 illustrates an exemplary structure of the hierarchical matrix repository stored in the database of the embodiment of FIG. 1;

FIG. 3 illustrates an embodied example of a system utilizing a hierarchic matrix repository;

FIG. 4 illustrates the exemplary information structure of the matrix in the system embodied in FIG. 3;

FIG. 5 illustrates factors available in the embodied evaluation system for analysing a group of subject entity companies;

FIG. 6 illustrates part of the value matrix when a user inputs a grade value for a factor;

FIG. 7 illustrates part of the value matrix at bypassing a factor;

FIG. 8 illustrates part of the value matrix at manual removal of bypassing of a factor;

FIG. 9 illustrates part of the value matrix at automatic removal of bypassing of a factor;

FIG. 10 illustrates part of the value matrix at disabling a factor;

FIG. 11 illustrates part of the value matrix at manual enablement of a disabled factor;

FIG. 12 illustrates part of the value matrix at automatic enablement of a disabled factor;

FIG. 13 illustrates part of the value matrix when the REF of factor expires:

FIG. 14 illustrated the steps of the embodied method.

### DETAILED DESCRIPTION OF THE INVENTION

The following embodiments are exemplary implementations of the present invention. Although the specification may refer to “an”, “one”, or “some” embodiment(s), reference is not necessarily made to the same embodiment(s), and/or a feature does not apply to a single embodiment only. Single features of different embodiments of this specification may be combined to provide further embodiments.

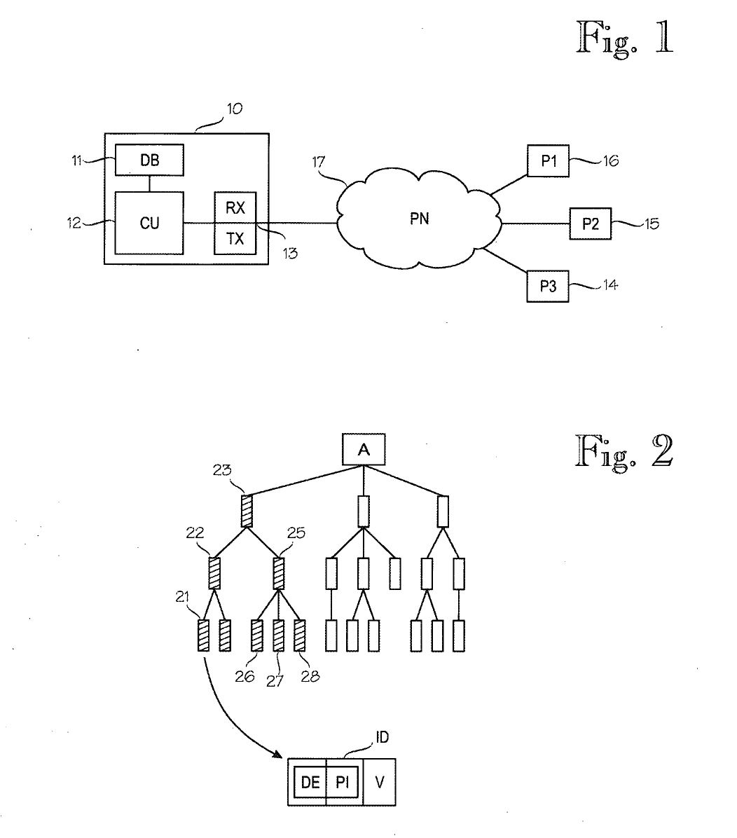

FIG. 1 illustrates an embodiment of an apparatus according to the invention. The apparatus of FIG. 1 represents a system 10 that comprises a database 11, a systematically arranged collection of data, structured so that it can be automatically retrieved or manipulated. The database 11 is configured to comprise a matrix repository, the structure of which will be described in more detail later on. The system also comprises a control unit 12, an element that comprises an arithmetic logic unit, a number of special registers and control circuits electrically interconnected to perform systematic execution of operations on received and/or stored data according to predefined, essentially programmed processes. A control unit 12 further comprises, or is electrically connected to a data medium where computer-readable data or programs can be stored to be loaded at execution of the operations.

The system of FIG. 1 also comprises an interface block 13 that is electrically connected to, and controlled by the control unit 12, and enables transferring data to the hierarchical matrix repository stored in the database 11. The implementation of an interface block 13 varies according to the application, and may be a simple boundary for, for example, an external physical connection. In the other end, the interface block 13 may be a sophisticated functional element that provides a network interface to a plurality of input nodes over various communication access types and even some preprocessing functions for feeding the input data to the control unit 12 in a structured form. In the embodiment of FIG. 1, the interface block 13 has been illustrated as a packet data network interface through which input nodes 14, 15, 16 can access the database 11 over a packet data network 17 and input data to the hierarchical matrix repository stored in the database 11. Advantageously, the interface block 13 also enables outputting data from the database 11 locally and/or to one or more external nodes.

As an example, the present embodiment is described in more detail in the context of an information system where a plurality of independent information sources feed values to a hierarchical matrix repository stored in the database 11. The term independent in this context refers to a mode of operation where the element receiving the information has no direct control to the timing and extent of the information submitted by the source of information. Consequently, FIG. 1 can be interpreted to illustrate an information system where the information sources correspond to users of the information system. For a person skilled in the art it is clear that information sources may comprise, for example, independent electronic assessment systems or measurement circuits that independently feed information to the system.

In the embodiment, assessment information on one or more points of interests is collected from a plurality of information sources. In order to reach the plurality of information sources, users 14, 15, 16 are provided with access to the remote database 11 where the matrix repository is stored. The network connection 17 for implementing the access may comprise fixed or wireless connection, or a combination of each. On the basis of the assessments received from the users 14, 15, 16, the system 11 computes result matrices on the points of interest addressed by the users 14, 15, 16, and provides controllably the results back to the users 14, 15, 16. The result may be a value computed as an aggregated summary from the points of interest, or a result matrix that comprises a number of values computed for the points of interest. Thus, the operation to be implemented on the basis of the hierarchical matrix repository values in this embodiment relates to output function of one or more values that correspond with points of interest addressed by one or more information sources, or of one or more values computed on the basis of the one or more values that correspond with the points of interest addressed by one or more information sources.

In the present embodiment, the subject of the matrix repository is a financial entity, for example, a company providing consumables, services or the like (an enterprise, an organization). In the following, a subject of the matrix repository is called as a subject entity. The information sources are called here as participators, and represent a party that, for some reason, has an interest in one or more points of interest of one or more subject entities, and is therefore willing to assess the points of interest in the matrix repository, and to access various aggregated summaries computed on the basis of at least these points of interest. Examples of participators in the present embodiment comprise investors, suppliers, customers, analysts, and the like.

A requirement for a system for collecting and distributing assessment information is that it may be accessed by a plurality of users from distributed locations. In network systems, the client/server model provides a convenient way to interconnect users that are distributed across different locations. In the following, the embodied information system is shown in client/server environment, without restricting the scope of protection to the terms and physical elements used herein. Alternative models comprise, for example, master/slave, and peer-to-peer configurations.

FIG. 1 illustrates the embodiment in the server-client environment. A server provides services for other computers connected to it via a network. Correspondingly, the input nodes are illustrated as clients that are provided with controlled access to the server. The connection between clients and the server may be performed, for example, by means of TCP/IP message passing over the IP network, using http or a proprietary protocol to encode the client's requests and the server's responses. While TCP and IP specify two protocols at specific protocol layers, TCP/IP is used herein to refer to the entire protocol suite based upon these, including telnet, FTP, UDP and RDP. The server may run continuously (as a daemon), waiting for requests to arrive or it may be invoked by a higher-level daemon that controls a number of servers. For a person skilled in the art it is clear that the network may be implemented as a radio access network or as a fixed network or a combination of each.

FIG. 2 illustrates an exemplary structure of the hierarchical matrix repository stored in the database of the embodiment of FIG. 1. In a system according to the invention, points of interest of the subject entity form a multi-dimensional value space. Each point of interest is mapped to a factor, and the factors are arranged into a matrix such that each factor represents one matrix element, and each of the matrix elements can be individualised according to its location in the matrix. Within the plurality of factors, at least part of the factors are arranged to have an internal dependency with each other. A factor may have an assigned value, and due to internal dependency, any operation causing a change in a value of a factor typically necessitates an update on the values of at least the factors that have an internal dependency with the factor whose value is being changed. In an operational system, the values of one or more factors, or values derived on the basis of the one or more factors may be used to trigger or select an operation to be performed. The plurality of factors with an internal dependency may thus be processed in aggregated manner.

For conciseness, a matrix comprising the group of factors applicable in the system will be hereinafter referred to as value matrix. As an example of internal dependencies, a hierarchical matrix is described in the following. Other types of internal dependencies are possible within the scope of protection.

In the embodied example, the value matrix comprises a plurality of matrix elements, classified according to defined criteria into successive levels or layers such that each element of the system (except for the top element) is subordinate to a single other element. A factor F 21 corresponds with one unique point of interest and its format may be applied to matrix elements in each level of the value matrix. A point of interest relates here to an element that may be profiled individually by means of predefined set of attributes. Points of interest are typically specific to a system. For example, in a control system for a number of parallel continuous processes, points of interest may correspond to measurement points installed in similar locations in each of the processes. In the embodiment of FIGS. 1 and 2, a point of interest corresponds to a predefined characteristic of a subject entity, assessable by the participators.

In the embodied value matrix, the internal dependency of the hierarchical structure is implemented by recursion such that a factor comprises an identity field ID that is predefined by the operator of the information system, and one or more value fields V for values derived for the assessed point of interest. The identity field ID comprises a descriptor part DE and a position indicator PI part. The descriptors DE may be predefined for, for example, the current subject entity group by the operator of the information system and utilized in the same format for each of the subject entities. The position indicators PI may comprise rules, values or characters, based on which the position of the factor in the layered structure may be defined. For example, in the hierarchic structure, the position indicator comprises a reference to a parent factor the current factor is subordinated to. The description part DE may also be an unambiguous, electronically transferable standard technical or scientific definition for the factor. Through the description part DE the factor F may also advantageously be associated with a verbal definition that, as such, clearly defines the characteristic of a factor to the users of the embodied information system. The one or more values in the value fields V carry the evaluation or evaluations assigned to or computed for the factor F 21.

From the content point of view, the use of factors homogenize the conception of the points of interest with respect to a plurality of subject entities and participators, especially in continuous, recurring use. On the other hand, the factors can be flexibly adapted to a particular application area and for different types of subject entities. From the computing point, the factors can be repeated in each level of the matrix and thus they act as a referencing tool with which update on values may be aggregated in a simple and rapid way through the value matrix.

In its simplest form, an assessment by a participant comprises a step of assigning one or more numeral values to one or more factors. Correspondingly, assessment of an subject entity comprises assigning numerical values to a group of one or more factors, based on the assessor's personal view on the current status of the points of interest in the subject entity. Typically, a participator is interested and/or informed on part of the points of interest, and on a group of selected companies, and willing to input information on related topics only. In addition, a participator needs to be able to submit the information at a time convenient to her/him. Still, the results computed on the basis of the assessment should be available to the participator as soon as possible.

FIG. 2 illustrates the structure of part of the value matrix applicable to one group of subject entities. The factors are organized into a hierarchical structure, wherein one or more factors 21 is subordinated to a higher-level factor 22, which again is subordinated to a higher-level factor 23, and so forth. The use of position indicators PI allows directing operations controllably either to individual factors or to members of hierarchical layers individually. The number of applied layers corresponds to the dimensions of the factor matrix, and the level of analysis may thus be selected and managed automatically by identifying the factor.

Depending on a system, a variety of metrics, related scales and ranges may be employed with assessments without deviating from the scope of the current invention. In the embodied system the assessment is provided in form of numerical values.

Each factor of a value matrix typically has a value that may be, for example, an input value received from an input node, value computed on the basis of one or more input values, or an assigned default value. A result matrix refers herein to a matrix whose values are computed from values of factors, chosen and processed on the basis of a computing rule that is specific to the result matrix. The value of the highest factor in the result matrix may be called as an aggregated summary value. The matrix of FIG. 2 illustrates a result matrix that corresponds with a basic input by a participant on a subject entity.

The basic computing rule of the result matrix comprises typically a generic part that defines the direction(s) of the aggregation(s) and is derived inherently on the basis of the internal dependencies of the value matrix. For example, in the hierarchic structure of the current embodiment, the position indication PI of a first factor typically refers to a second factor to which the first is in subordinate relation. In such case the generic computing rule defines at least aggregating the update of values to a value of the referred second factor each time the corresponding value in the first factor is changed.

The generic part advantageously comprises vertical and horizontal definitions, according to which the update within and between matrix layers is implemented. When factors are arranged into a hierarchic matrix structure, as discussed above, a factor 22 may have a parent factor 23 to which the factor is subordinated to, one or more sibling factors 25 subordinated to the same parent factor 23, and one or more child factors 21 subordinated to the factor 22.

As an example of vertical generic definitions, a change of value of factor 22 may, depending on the computation rule of the aggregated summary matrix, cause changes to be aggregated to values of all the factors in the same factor family, illustrated in FIG. 2 by lineation.

As an example of horizontal generic definitions, value of a parent factor 25 may be computed by weighing the input grades of child factors 26, 27, 28 according to input weight values. Weights may be arranged to be given in percentages, whereby the total of weights of siblings factors 26, 27, 28 needs to be 100% at all times. A change in weight value in any of the sibling factors 26, 27, 28 may cause a change of values of all factors 23, 25, 26, 27, 28.

In addition, the basic computing rule of the result matrix may also comprise a derivation part that defines the equations used in computing the new values for the factors of the result matrix. For example, continuing the previous example, the derivation part of the computing rule of the value matrix may comprise a definition to update the value of each superordinate factor by re-calculating the average of the values of the factors in the subordinate level.

On the basis of the factor values, the system is configured to compute a number of result matrices, each associated with a basic computing rule that comprises a specific set of one or more definitions. In the embodied system, a value matrix of a participant on a subject entity, comprising at least some computed values represents a basic result matrix. Values in the result matrices may also be combined in the other dimensions in order to generate additional result matrices for further perusal in various applications. For example, in the embodiment of FIGS. 1 and 2, a participant summary matrix may be generated on the basis of value matrices combined in the participant dimension. A consensus matrix for a subject entity company A corresponds with a value matrix where the values for factors are computed as an average of values submitted by a group of participators. A sector matrix may be generated on the basis of consensus matrices further combined in the subject entity dimension to comprise an average summary of a number of subject entity companies that operate within a same line of business. Due to internal dependencies in and possibly between the result matrices, any change in any of the values of a factor will inherently cause a number of computations in order to achieve the result matrices or aggregated summaries.

In order to reduce the computing effort, the factors are further configured with a number of predefined states that may be utilized in combination with internal dependencies to optimise the number of matrix operations in the system. A matrix operation is targeted on a factor and takes place as a result of a specific operational condition associated with a change of value. A matrix operation on a factor occurs as a result of an input action, i.e. when the factor corresponds with the point of interest addressed by the factor, or as a result of an antecedent matrix operation of an internally dependent factor. At matrix operation on the factor, the system is configured to check the current state of the factor and the type of the matrix operation, and update the state of the factor accordingly. The new state is then used to determine, whether a new value needs computed for the factor or not. The new state may also be used to determine whether the matrix operation is aggregated according to the structural dependency or not. Additionally, the new state may also be used to determine in which way the value of the factor is used for performing the operation in the system. Due to the optimal integration of the internal dependency and the factor states, the number of matrix operations for updating the result matrices applied in the system can be significantly reduced without interfering with the random nature of the input operations.

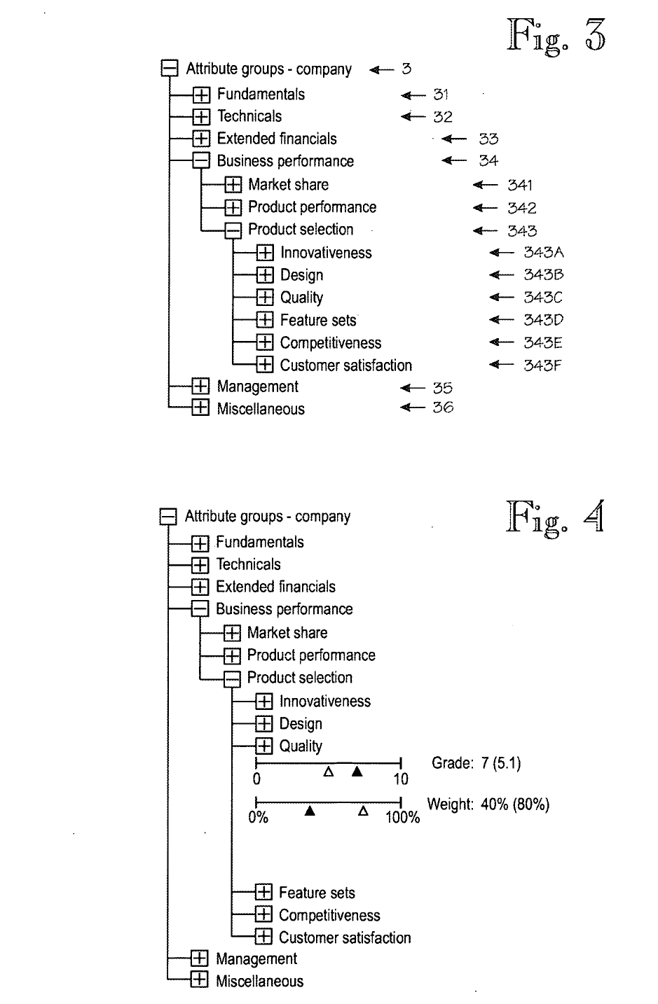

In the following, the general solution applying the factor states is illustrated in more detail, continuing with the embodiment of FIGS. 1 and 2. As an example of a system utilizing a hierarchic matrix repository, FIG. 3 illustrates an industrial application for generating consensual information on non-financial value drivers of listed companies to the equity market. Assessable points of interest on companies under assessment are formalized to factors. The first level of factors of the exemplary assessment is related to the identification of the subject entity, Company 3. The next level of factors comprises six main groups of Fundamentals 31, Technicals 32, Extended financials 33, Business performance 34, Management 35, and Miscellaneous 36, the position indicator of each factor comprising a reference to the parent factor Company 3. The main group Business performance 34 is further divided into three sub-groups: Market share 341, Product performance 342, and Product selection 343, the position indicator of each factor comprising correspondingly a refer-ence to the parent factor Business performance 34. The subgroup Product selection 343 divides further into six subgroups Innovativeness 343A, Design 343B, Quality 343C, Feature sets 343D, Competitiveness 343E, Customer satisfaction 343F, the position indicator of each factor comprising correspondingly a reference to the parent factor Product selection 343.

Now, for example, a point of interest of the business performance of the assessed company in general, i.e. how the market share is divided, how have the products performed, how does the product selection look like in the competitive terms, may be assessed by a value given to a factor Business performance. The identity field of the factor comprises the descriptor “Business performance” 34 and reference to the parent factor “Company” 3, which positions the attribute to the second highest layer in the matrix. By submitting a value ‘8’, the user may evaluate the business performance of the Company to be satisfactory.

At will of the user, the assessment of this factor may, however, be brought into a deeper level by analyzing separately the particular aspects of the factor. Thus a point of interest of the competitiveness of the selection may be assessed by a value given to the factor Product selection 343. The parent factor to the factor Product selection 343 is the factor Business performance 34, whose parent is the factor Company 3. This positions the attribute Product selection 343 to the third highest layer in the matrix. Analogously, attributes subgroups Innovativeness 343A, Design 343B, Quality 343C, Feature sets 343D, Competitiveness 343E, Customer satisfaction 343F provide voluntary means for even deeper analysis on this particular aspect of the value driver. In order to focus the analyzing effort only to the factors that are relevant for the participant, and to which the most valuable knowledge is thus associated, it is essential that the choice of factors and grades are as flexible as possible. This enhances the accuracy of the results and improves the value of the output. On the other hand, it is essential that the processing time, especially the time for computing the results does not increase when the essential flexibility to the input procedure is facilitated.

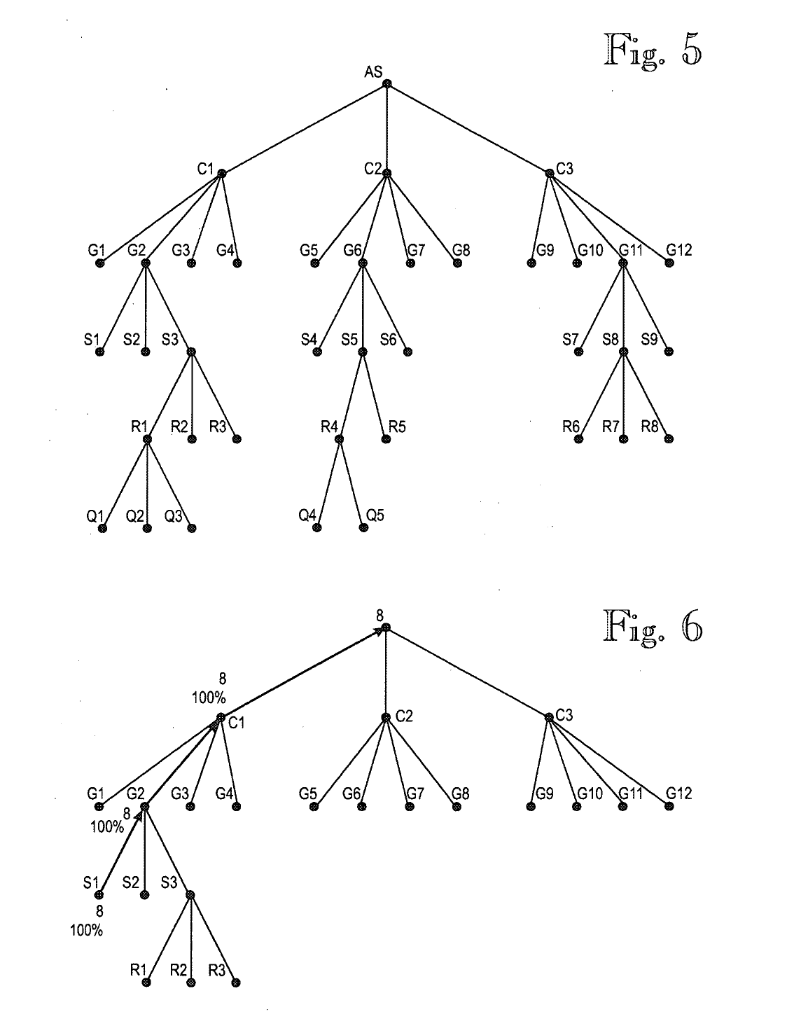

FIG. 4 illustrates the information structure of the factors in the embodiment of FIG. 3. Two exemplary metrics are employed in the embodied assessment. The first metric is denoted as the grade G and corresponds to a mark in the range of 1-10. The second metric is denoted as the weight W and corresponds to the relative weight of the factor in question in relation to the other factors within the same group in question in relation to the other factors within the same group, in the range of 1-100%. The use of more than one metric provides an inherent averaging mechanism that provides the factors with applied perspectives to the commercial utilization of information in the hierarchic attribute matrix. For a person skilled in the art it is clear that several other types of metrics may be used. For example, a third metric could be denoted as confidence C and used to gauge the level of knowledge the participator perceives to possess on the factor in question, in the range of 1-10.

In the current embodiment, a user gives his or her input through the user interface of the client workstation for one or more factors. This generates an input record, the input record comprising identification of the factor and values for one or more of the metrics G, W applied to that factor. The client workstation may comprise a pre-processing unit for pre-processing the records in the user end, or the client workstation may be configured to send the records as such to the server, or the records may be partly processed in either end.

In the server end the new value is received. Since the user may freely decide the time of providing the assessment and also freely choose the subject companies and the level of detail used in the assessment, such input in a conventional system would occur a complete re-calculation of practically all the matrix elements of the various result matrices applied in the system, or a complex stage of determining which of the matrix elements are affected and which are not. This disadvantage is alleviated by solutions according to the invention.

As a first example, computation of a value matrix of the participant for the subject entity company is discussed in more detail with FIGS. 5 to 14. The value matrix of FIG. 5 illustrates exemplary factors available in the embodied evaluation system for analyzing a group of subject entity companies. The internal dependency of the factors is hierarchic, and factors are presented in a treelike matrix where a factor is referenced by a combination of the layer name of the factor and the layer names of the parent factors. Thus a factor R3 in layer 3 may be referenced in brief by character string C1G2S3R3. In the following, some exemplary input instances and associated computing rules are shown. FIG. 5 shows the complete exemplary value matrix in the beginning when there are no values input by the participants, and the factor state parameter values of all factors are recorded as ‘Inactive’.

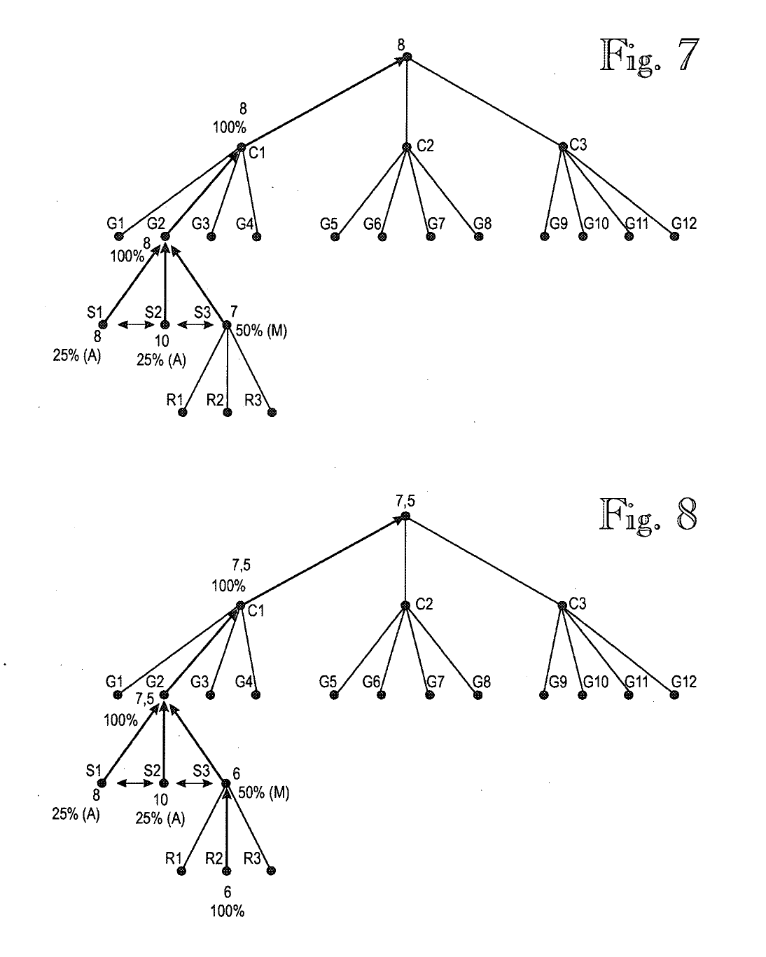

FIG. 6 illustrates part of the same value matrix when a user inputs a grade value 8 for a factor C1G2S1. When the system detects this new input value from a participant, it updates the state of the factor on the basis of the combination of the current result matrix, matrix operation and state of the factor C1G2S1. In this case, the combination includes to ‘value matrix’ AND ‘input’ AND ‘inactive’.

In addition to the generic part and the derivation part, the computing rule of the value matrix comprises a factor state part that maps the combination to changing the factor state parameter value of factor C1G2S1 to ‘Active’.

Additionally, the value of the ‘Active’ factor is computed and aggregated to a factor to which the factor is subordinated. The total weight between active sibling factors is always 100%, but since no other sibling factors are yet active, the weight is automatically set to 100%. The new value for the factor C1G2S1 can thus be determined as G=8 and W=100%. The new grade value G is multiplied with the new weight W value, and the resulting grade 8 is aggregated as the input grade value to the parent factor C1G2.

The current state of factor C1G2 is initially ‘inactive’. As above, when the system detects a new input value, now resulting from the aggregation, it updates the state of the factor. The combination of the current result matrix, matrix operation and state of the factor C1G2 includes ‘value matrix’ AND ‘computed’ AND ‘inactive’. The factor state part of the computing rule of the value matrix maps the combination to changing the factor state parameter value of factor C1G2 to ‘Automatic, ‘Automatic’ factors are also considered active and induce determination of new factor values, and aggregation to the parent value. However, the different state enables a further differentiation between computed values and true input values. This differentiation may be valuable especially in performing the operation in the system. For example, in the embodied system, the output operation may be configured to show the computed and input values with different colours. In the absence of active siblings, the weight value of the parent factor C1G2 is again automatically set to 100%, and the new value for the factor C1G2 may be determined as G=8 and W=100%. Additionally, the grade value G of the parent factor C1G2 is multiplied with the current weight W value, and the resulting grade 8 is aggregated as an input value to the parent factor C1.

Check on factor C1 reveals the same combination and the state becomes ‘Automatic’, and the new values may be determined in a similar manner as for C1G2. Since only C1 is active or automatic in level 1, the grade for participator aggregated summary for the company becomes in this case 8. According to the embodiment, the inactive factors could be excluded from calculations, and at the same time the output operation of the system could be improved.

Bypassing of factors takes place when a participator inputs a value for a parent factor that is in ‘Automatic’ state. This means that the value of the parent factor is first a weighted average of the values of the child factors, and the aggregation is overridden by a direct value. When the automatic value is replaced by the input value the input value needs to be included in computing the aggregated summaries, but the bypassed children factors are not. This is illustrated in FIG. 7 that shows the same part of the value matrix, but this time the value matrix comprises some active values and a participator inputs a grade value 7 and weight value 50% for a factor C1G2S3.

When the system detects this new input value from a participant, it updates the state of the factor on the basis of the combination of the current result matrix, matrix operation and state of the factor C1G2S3. In this case, the combination includes to ‘value matrix’ AND ‘input’ AND ‘automatic’. The factor state part of the computing rule of the value matrix maps the combination to changing the factor state parameter value of factor C1G2S3 to ‘Bypassed, Also ‘Bypassed’ factors are considered active and induce determination of new factor values, and aggregation to the parent value. Additionally, the different state also enables a further differentiation between computed values and true input values. Furthermore, the bypassed state also initiates a further aggregation definition according to which the state of the subordinate factor is also changed. The recorded grade of factor C1G2S3R2 thus remains ‘6’, but the state of the factor is changed to ‘Parent bypassed’. The factor state part of the computing rule also defines that the factor in ‘Parent bypassed’ state is not used for computing the value matrix.

The weight of the other ‘Active’ or ‘Automatic’ sibling factors C1G2S1 and C1G2S2 is now automatically adjusted to 25%. In consequence, the grade value 8 of C1G2S1 is multiplied with the current weight W value 25%, the grade value 10 of C1G2S2 is multiplied with the current weight W value 25%, the grade value 7 of C1G2S3 is multiplied with the current weight W value 50%, and the resulting grade 8 is aggregated as an input grade value of the parent factor C1G2. The update of factors C1G2 and C1 is performed as described as above, and the grade for participator aggregated summary for the company is in this case 8.

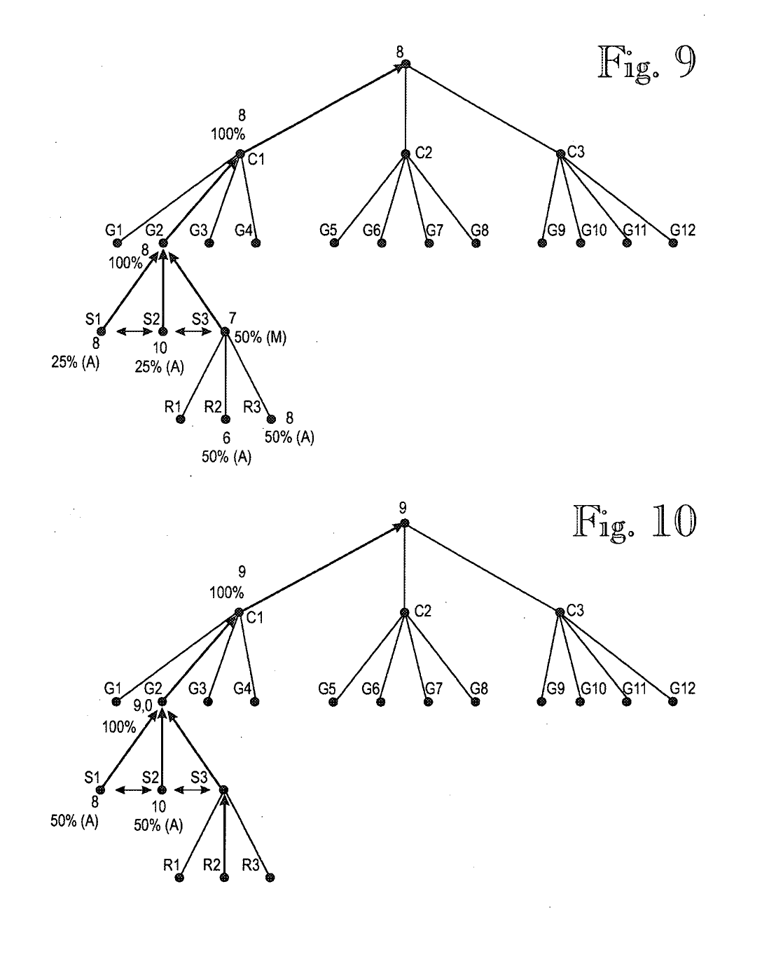

On the other hand, as illustrated in FIG. 8, since the original value of C1G2S3R2 is stored, through the factor state definitions the bypassing can also be easily removed. In this case, the combination includes to ‘value matrix’ AND ‘cancel’ AND ‘bypassed. The factor state part of the computing rule of the value matrix maps the combination to changing the factor state parameter value of factor C1G2S3 to ‘Automatic’. At the same time, the factor state parameter value of C1G2S3R2 is changed to ‘Active’, and the weight is automatically set to 100%. The grade of factor C1G2S3 becomes 6, and the weight remains 50%. The weight of the other sibling factors C1G2S1 and C1G2S2 remains adjusted to 25%. The grade value 8 of C1G2S1 is multiplied with the current weight W value 25%, the grade value 10 of C1G2S2 is multiplied with the current weight W value 25%, the grade value 6 of C1G2S3 is multiplied with the current weight W value 50%, and the resulting grade 7.5 is recorded as the grade value of the parent factor C1G2. The weight value of the parent factor C1G2 is set to 100%, and the factor state parameter value of C1G2 remains ‘Automatic’. The resulting grade 7,5 is recorded as the value of the parent factor C1, C1 remains ‘Automatic’ and the weight remains set to 100%.

Accordingly, the grade for participator aggregated summary for the company is in this case 7.5.

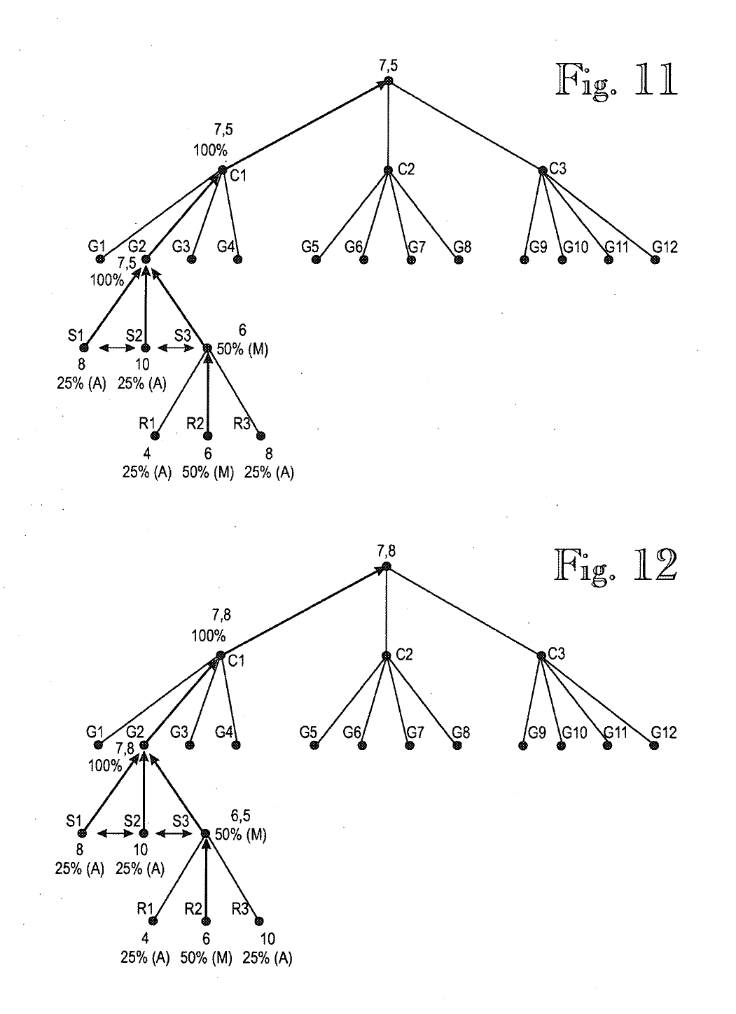

Using an appropriate computing rule, the bypassing can also be removed automatically. In this case, the participant provides a new input value 8 with weight 50% to a factor C1G2S3R3 that is in an ‘Inactive’ state, while the other sibling factor C1G2S3R2 is in a ‘Parent bypassed’ state. As illustrated in FIG. 9, the state of factor C1G2S3R3 changes normally from ‘Inactive’ to ‘Active’ state. The combination for C1G2S3R2 includes to ‘value matrix’ AND ‘input to sibling’ AND ‘parent bypassed’, and the factor state part of the computing rule of the value matrix maps the combination to returning the original stored grade value of C1G2S3R2 and changing the factor state parameter value of C1G2S3R2 to ‘Active’. The weights of factors C1G2S3R2 and C1G2S3R3 are automatically balanced to 50%. The state of factor C1G2S3 becomes again ‘Automatic’, and C1G2S3R2 is changed to ‘Active’. The grade of factor C1G2S3 becomes 7, and the weight remains 50%. The weight of the other sibling factors C1G2S1 and C1G2S2 remains adjusted to 25%. The grade value 8 of C1G2S1 is multiplied with the current weight W value 25%, the grade value 10 of C1G2S2 is multiplied with the current weight W value 25%, the grade value 7 of C1G2S3 is multiplied with the current weight W value 50%, and the resulting grade 8 is recorded as the grade value of the parent factor C1G2. The weight value of the parent factor C1G2 is set to 100%, and the factor state parameter value of C1G2 remains ‘Automatic’. The resulting grade 8 is recorded as the value of the parent factor C1, C1 remains ‘Automatic’ and the weight remains set to 100%. Accordingly, the grade for participator aggregated summary for the company in this case becomes 8. As shown above, through use of ‘Bypassed’ and ‘Parent bypassed’ factor states, the aggregation may thus be scoped correctly and flexibly re-scoped either manually or automatically.

Another use case where the factor states provide several advantages is where a participator needs to quickly disable a factor and all its child factors from aggregated summaries. For example, a consensus aggregated summary on subject entity A made available to a participant X may be generated on the basis of value matrices combined in the participant dimension to store an average summary of participator input values for a subject entity company A, excluding the input values of participant X. Such an arrangement may be used to restrict the view of assessors to the values and eliminates the possibility to misuse the assessment only to influence the consensus.

The disabling use case is illustrated in FIG. 10. In this case, the combination includes ‘value matrix’ AND ‘disable’ AND ‘active/automatic’. It is also assumed that in level 4, factor C1G2S3R1 has been given grade 4 without explicit weight, factor C1G2S3R2 grade 6 with weight 50% and factor C1G2S3R3 grade 8 without explicit weight. Accordingly, the state of factor C1G2S3 changes to ‘Disabled’, and the weights of factors C1G2S1 and C1G2S2 are automatically balanced to 50%. The state of factors C1G2S3R1, C1G2S3R2, and C1 G2S3R3 become ‘Parent disabled’, which means that the values will not be included in computations of aggregated summaries. The grade value 8 of C1G2S1 is multiplied with the current weight W value 50%, the grade value 10 of C1G2S2 is multiplied with the current weight W value 50%, and the resulting grade 9 is recorded as the grade value of the parent factor C1G2. The weight value of the parent factor C1G2 is set to 100%, and the factor state parameter value of C1G2 remains ‘Automatic’. The resulting grade 9 is recorded as the value of the parent factor C1, C1 remains ‘Automatic’ and the weight remains set to 100%. Accordingly, the grade for participator aggregated summary for the company in this case becomes 9.

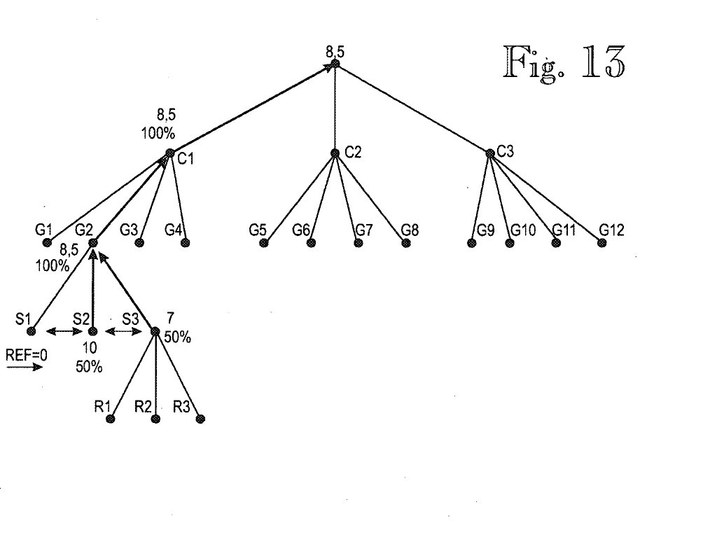

Correspondingly, a participator may also need to manually enable a factor and all its child factors into aggregated summaries. Such use case is illustrated in FIG. 11. In this case, the combination includes ‘value matrix’ AND ‘enable’ AND ‘disabled’. Accordingly, the state of factors C1G2S3R1, C1G2S3R2, and C1G2S3R3 changes to ‘Active’, and the weights of factors C1G2S3R1 and C1G2S3R3 are automatically balanced to 25%. The grade value 4 of C1G2S3R1 is multiplied with the current weight W value 25%, the grade value 6 of C1G2S3R2 is multiplied with the current weight W value 50%, the grade value 8 of C1G2S3R3 is multiplied with the current weight W value 25%, and the resulting grade 6 is recorded as the grade value of the parent factor C1G2S3. The state of factor C1G2S3 becomes ‘Automatic’, and the weight remains 50%. The weight of the other sibling factors C1G2S1 and C1G2S2 remains adjusted to 25%. The grade value 8 of C1G2S1 is multiplied with the current weight W value 25%, the grade value 10 of C1G2S2 is multiplied with the current weight W value 25%, the grade value 6 of C1G2S3 is multiplied with the current weight W value 50%, and the resulting grade 7.5 is recorded as the grade value of the parent factor C1G2. The weight value of the parent factor C1G2 is set to 100%, and the factor state parameter value of C1G2 remains ‘Automatic’. The resulting grade 7.5 is recorded as the value of the parent factor C1, and aggregated to a value of the participator aggregated summary for the company.

By means of the factor state values, it is also possible to automatically enable disabled factors for aggregated summaries. Such use case is illustrated in FIG. 12. In this case, the combination includes ‘value matrix’ AND ‘input’ AND ‘parent disabled’. According to the associated computing rule, the new value is provided to factor C1G2S3R3, the state of factors C1G2S3R1, C1G2S3R2, and C1G2S3R3 changes to ‘Active’, and the weights of factors C1G2S3R1 and C1G2S3R3 are again automatically balanced to 25%. The grade value 4 of C1G2S3R1 is multiplied with the current weight W value 25%, the grade value 6 of C1G2S3R2 is multiplied with the current weight W value 50%, the grade value 10 of C1G2S3R3 is multiplied with the current weight W value 25%, and the resulting grade 6.5 is recorded as the grade value of the parent factor C1G2S3. The state of factor C1G2S3 becomes ‘Automatic’, and the weight remains the explicitly given 50%. The weight of the other sibling factors C1G2S1 and C1G2S2 remains adjusted to 25%. The grade value 8 of C1G2S1 is multiplied with the current weight W value 25%, the grade value 10 of C1G2S2 is multiplied with the current weight W value 25%, the grade value 6.5 of C1G2S3 is multiplied with the current weight W value 50%, and the resulting grade 7.8 is recorded as the grade value of the parent factor C1G2. The weight value of the parent factor C1 G2 is set to 100%, and the factor state parameter value of C1G2 remains ‘Automatic’. The resulting grade 7.8 is recorded as the value of the parent factor C1, and aggregated to a value of the participator aggregated summary for the company.

As shown above, through use of ‘Disabled’ and ‘Parent disabled’ factor states, the relevant factors can be identified and activated for computing the result matrices quickly and in a straightforward manner.

In the above examples, the input instances and the computing rules relate to the computation of the basic value matrix of a participant on a subject entity. As discussed earlier, the system allows computations of a variety of result matrices, each of which may be associated with an own computing rule.

For example, the state of the factors may alternatively be determined on the basis of a reciprocity expiration factor (REF). Initially all the factors in the value matrix for the participator are CLOSED. Each time a participator implements a predefined action on the factor, for example provides a grade or predefined amount of grades for a factor, the factor is changed to OPEN state. Each time a participator inputs a new value for the factor, the REF of the factor is reset. After reset the REF may be updated, either continuously based on one or more update rules, or by the operator, in response to some sudden changes in the operative environment. REF may, for example, be configured to act as a timer, a timepiece that measures a time interval and signals its end. The state of the factor is determined on the basis of the current value of its REF. REF in OPEN state may reach a predefined threshold value, for example at the predefined time interval of the timer, and the state of the factor changes to CLOSED. REF may be used to indicate an factor state, associated with a particular factor state definition in the computing rule of a consensus matrix.

Consensus matrix represents an aggregated summary computed on the basis of value matrices of a number of participators. Values of a consensus matrix are of great interest to the participants and to the subject entities. In view of the current embodiment, a low value in the aggregated summary in the consensus matrix for a company may be configured to trigger an alarm that is distributed to a group of participants who, for example, through input analysis have indicated interest in the subject entity. On the other hand, a low value in the aggregated summary in the consensus matrix for a company may be configured to trigger an alarm to the subject entity company and thereby initiate corrective actions as soon as possible.

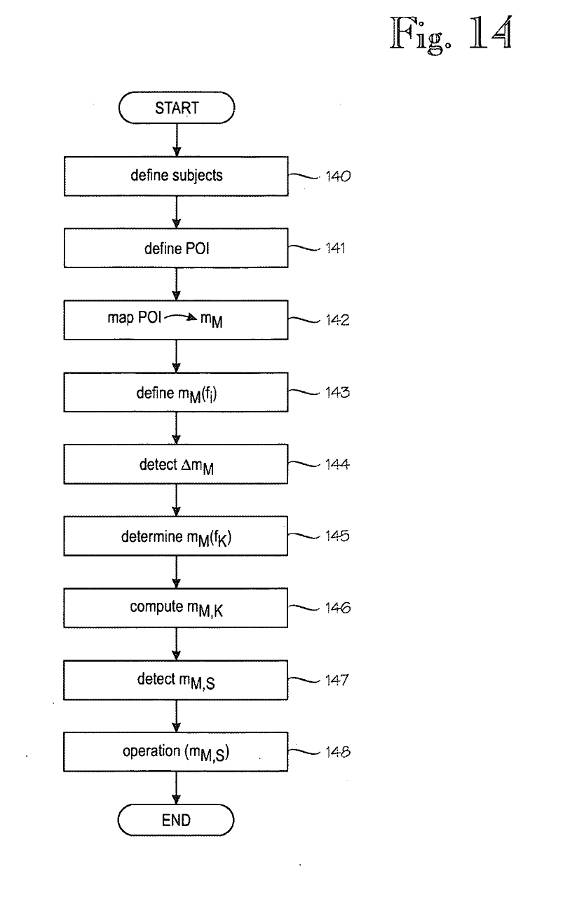

FIG. 13 illustrates again the same part of the value matrix but this time in a situation where the REF of factor C1G2S2 for the company by the participator expires. The factor state that initiates computing the result matrix refers now to ‘REF=0’. This factor state is not relevant to computing the value matrix of the subject entity and the participator. Accordingly, the associated computing rule of the value matrix may define that the combination of ‘value matrix’ AND ‘REF=0’ may be omitted and the value matrix for the company by the participator need not be re-computed.

However, the factor state REF=0’ is relevant to computing the consensus matrix of the subject entity and the participator. Accordingly, the combination of ‘consensus matrix’ AND ‘REF=0’ defines that factor C1G2S2 from the participator is disabled from the computation of the consensus matrix. As shown above, use of REF factor states ensures that consensus information provided to the other participants is based on information that is continuously up to date.

FIG. 14 illustrates the steps of a method of operating the embodied apparatus. In step 140 the operator of the system defines operational subjects by selecting the companies to be assessed by the users of the system. In step 141 points of interest POI on the operational subjects are established. Exemplary points of interest applicable in the system are illustrated in FIG. 3. In step 142 the points of interest are mapped into matrix elements m_{M} of a value matrix M, and possible additional result matrices. As an example of the result matrix, the value matrix comprises factors corresponding with each of the points of interest assessable on the selected companies. The factors follow an internal dependency such that a matrix operation targeted to at least one matrix element of the result matrix induces a corresponding matrix operation directed to at least one other, internally dependant matrix element of the matrix. For example, in the embodied system where the internal dependency reflects the hierarchic structure of the matrix, a change of value of one factor is aggregated to values of all the factors in the same factor family. A change in weight value in any of the sibling factors may also cause a change of value of all factors subordinated to the same parent. In step 143, one or more factor states m_{M}(f) are defined. A factor state m_{M}(f) is identifiable by a combination of a result matrix, matrix operation and previous state of the targeted matrix element. In addition, the factor state is associated with a specific computing rule, or more specifically, a factor state definition in the computing rule of the result matrix.

During operation, a matrix operation on a factor occurs as a result of an input action, i.e. when the factor corresponds with the point of interest addressed by the factor, or as a result of an antecedent matrix operation of an internally dependent factor. At detecting (step 144) a matrix operation Δm_{M}, the system determines (step 145) a new matrix element state m_{M}(fₖ) from the combination of the result matrix, the matrix operation and the matrix element state of the targeted matrix element, and computes (step 146) the new factor value m_{M,k} according the computing rule associated with the factor state. In addition, the system also aggregates the factor value and/or the factor state according the computing rule associated with the factor state.

At given time, for example after each update of the factor values in the value matrix and the possible further result matrices, the system reads (step 147) a predefined value m_{M,s} of a predefined result matrix, or a predefined combination of values in a predefined result matrix, and performs (step 148) an operation of the apparatus accordingly. In the currently embodied system the operation comprises outputting at least part of the values of the result matrices to the participator that provided the values inducing the update.

In an aspect, the invention provides a computer program product encoding a computer program of instructions for executing a computer process.

In another aspect, the invention provides a computer program distribution medium readable by a computer and encoding a computer program of instructions for executing a computer process.

The distribution medium may include a computer readable medium, a program storage medium, a record medium, a computer readable memory, a computer readable software distribution package, a computer readable signal, a computer readable telecommunications signal, and/or a computer readable compressed software package.

Embodiments of the computer process are shown and described in conjunction with FIG. 14. The computer program may be executed in the signal processing unit of the transmitter and/or the receiver.

Even though the invention is described above with reference to an example according to the accompanying drawings, it is clear that the invention is not restricted thereto but it can be modified in several ways within the scope of the appended claims.

1-19. (canceled)

20. A method of operating an apparatus, comprising:
defining an operational subject;
defining points of interest of the operational subject;
mapping the points of interest into matrix elements of one or more result matrices, one or more of the matrix elements having at least one internal dependency such that a matrix operation targeted to at least one matrix element of the result matrix induces a corresponding matrix operation directed to at least one other, internally dependant matrix element of the matrix;
defining one or more matrix element states, a matrix element state being identifiable by a combination of a result matrix, matrix operation and previous state of the targeted matrix element, and associated with a specific computing rule;
at matrix operation of a factor in a result matrix:
determining a new matrix element state from the combination of the result matrix, the matrix operation and the matrix element state of the targeted matrix element;
computing the factor value and aggregating the factor value and/or the factor state according the computing rule associated with the factor state;
detecting a combination of values of predefined one or more matrix elements in the computed result matrix;
performing an operation of the apparatus, said operation being determined on the basis of the detected combination of values.

21. A method according to claim 20, wherein the apparatus comprises a server connected to a plurality of external nodes and the step of performing the operation comprising outputting the values of the result matrix from the server to an external node.

22. A method according to claim 20, wherein the operational subject is a subject entity company, and the points of interest correspond with a predefined group of attributes available for assessing the subject entity company.

23. A method according to claim 20, wherein the internal dependency forms a hierarchic structure where a matrix operation targeted to a first matrix element of the result matrix induces a corresponding matrix operation directed to at least a second matrix element to which the first matrix element is subordinated to.

24. A method according to claim 20, wherein a matrix operation targeted to a first matrix element of the result matrix induces a corresponding matrix operation directed to one or more matrix elements subordinated to a same second matrix element the first matrix element is subordinated to.

25. A method according to claim 20, wherein the operation of the apparatus is responsive to the matrix element state.

26. An apparatus comprising:
a database;
a control unit;
the database being configured to comprise matrix elements corresponding with predefined points of an of the operational subject;
the control unit being configured to compute one or more result matrices one or more of the matrix elements having at least one internal dependency such that a matrix operation targeted to at least one matrix element of the result matrix induces a corresponding matrix operation directed to at least one other, internally dependant matrix element of the result matrix;
the control unit being configured to identify, at matrix operation, a matrix element state by a combination of a result matrix, matrix operation and previous state of the targeted matrix element, and associate the matrix element state with a specific computing rule;
the control unit being configured to detect a matrix operation, and:
determine a new matrix element state from the combination of the result matrix, the matrix operation and the matrix element state of the targeted matrix element;
compute the factor value and aggregate the factor value and/or the factor state according the computing rule associated with the factor state;
detect a predefined combination of values of one or more matrix elements in the computed result matrix;
perform an operation in the system, said operation being determined on the basis of the detected combination of values.

27. An apparatus according to claim 26, wherein the apparatus comprises an interface block for connecting to a plurality of external nodes.

28. An apparatus according to claim 27, wherein the operation of the apparatus comprises outputting values of a result matrix to an external node.

29. An apparatus according to claim 26, wherein the operational subject is a company, and the points of interest correspond with a predefined group of attributes available for assessing the subject entity company.

30. An apparatus according to claim 26, wherein the internal dependency forms a hierarchic structure where a matrix operation targeted to a first matrix element of the result matrix induces a corresponding matrix operation directed to at least a second matrix element to which the first matrix element is subordinated to.

31. An apparatus according to claim 26, wherein a matrix operation targeted to a first matrix element of the result matrix induces a corresponding matrix operation directed to one or more matrix elements subordinated to a same second matrix element the first matrix element is subordinated to.

32. An apparatus according to claim 26, wherein the operation of the apparatus is responsive to the matrix element state.

33. An apparatus according to claim 26, wherein the apparatus is a server accessible to a plurality of network nodes.

34. An apparatus according to claim 27, wherein the control unit is configured to detect a matrix operation in response to receiving an input value from an external node.

35. An apparatus according to claim 32, wherein the control unit is configured with a state parameter measuring expiry of values for the factors, and to detect a matrix operation in response to expiry of a value for a factor.

36. A computer program product encoding a computer process of instructions for executing a computer process for
defining an operational subject;
defining points of interest of the operational subject;
mapping the points of interest into matrix elements of one or more result matrices, one or more of the matrix elements having at least one internal dependency such that a matrix operation targeted to at least one matrix element of the result matrix induces a corresponding matrix operation directed to at least one other, internally dependant matrix element of the matrix;
defining one or more matrix element states, a matrix element state being identifiable by a combination of a result matrix, matrix operation and previous state of the targeted matrix element, and associated with a specific computing rule;
at matrix operation of a factor in a result matrix:
determining a new matrix element state from the combination of the result matrix, the matrix operation and the matrix element state of the targeted matrix element;
computing the factor value and aggregating the factor value and/or the factor state according the computing rule associated with the factor state;
detecting a combination of values of predefined one or more matrix elements in the computed result matrix;
performing an operation of the apparatus, said operation being determined on the basis of the detected combination of values.

37. A computer program distribution medium readable by a computer and encoding a computer program of instructions for executing a computer process for operating an apparatus, the process including:
defining an operational subject;
defining points of interest of the operational subject;
mapping the points of interest into matrix elements of one or more result matrices, one or more of the matrix elements having at least one internal dependency such that a matrix operation targeted to at least one matrix element of the result matrix induces a corresponding matrix operation directed to at least one other, internally dependant matrix element of the matrix;
defining one or more matrix element states, a matrix element state being identifiable by a combination of a result matrix, matrix operation and previous state of the targeted matrix element, and associated with a specific computing rule;
at matrix operation of a factor in a result matrix:
determining a new matrix element state from the combination of the result matrix, the matrix operation and the matrix element state of the targeted matrix element;
computing the factor value and aggregating the factor value and/or the factor state according the computing rule associated with the factor state;
detecting a combination of values of predefined one or more matrix elements in the computed result matrix;
performing an operation of the apparatus, said operation being determined on the basis of the detected combination of values.

38. The computer program distribution medium of claim 37, the distribution medium comprising a computer readable medium, a program storage medium, a record medium, a computer readable memory, a computer readable software distribution package, a computer readable signal, a computer readable telecommunications signal, and a computer readable compressed software package.
